(19) United States
(12) Patent Application Publication
(10) Pub. No.: US 2026/0212511 A1
(43) Pub. Date: Jul. 23, 2026

(54) WATERSHED IMAGE SEGMENTATION WITH OPTIMIZED PROCESSING OF IMAGE DATA BY ITERATIVE RECONSTRUCTION

(71) Applicant: SAFRAN ELECTRONICS & DEFENSE, PARIS (FR)

(72) Inventors: François LEROY, MOISSY-CRAMAYEL (FR); Farid OUDYI, MOISSY-CRAMAYEL (FR); Carole PREUX, MOISSY-CRAMAYEL (FR); Clément GUEROUT, MOISSY-CRAMAYEL (FR)

(21) Appl. No.: 19/140,105

(22) PCT Filed: Dec. 18, 2023
(86) PCT No.: PCT/FR2023/052030

§ 371 Date: Jun. 17, 2025

(30) Foreign Application Priority Data
Dec. 20, 2022 (FR) FR2213941

(51) Int. Cl. G06T 7/155

(52) U.S. Cl. CPC G06T 7/155; G06T 2207/20152

(57) ABSTRACT

A method, implemented by a computing unit, includes obtaining an image, each pixel of the image being associated with: a label indicating whether the pixel is a source pixel, the sources having local pixel intensity extrema of a first type; an indicator of a source associated with the pixel; an intensity of the pixel; a pixel intensity extremum of a second type on a path between the source associated with the pixel and the pixel, the second type of pixel intensity extremum being the inverse of the first type of pixel intensity extremum; and, until a stop criterion is satisfied, at least one iteration of traversing successive pixels of the image.

### TECHNICAL FIELD

This disclosure relates to the field of image processing. More particularly, this disclosure relates to the field of image segmentation techniques.

### PRIOR ART

Image segmentation consists of separating an image into one or more regions.

The image segmentation technique known as “watershed” segmentation allows an image to be segmented into different regions corresponding to different light sources or objects in the image.

FIG. 1 shows an example of an image used as a basis for watershed segmentation.

The image Img1 is a two-dimensional representation, in which each pixel is associated with an intensity value. The image Img1 may be obtained in different ways. For example, it may be obtained as output from a sensor of infrared, radio, ultraviolet, or visible light, or may be generated by a computer program.

The image Img1 shows the different intensity values of the pixels. In the example in FIG. 1, the image is an image obtained by an infrared sensor, and the intensity of each pixel decreases with the gray level, a darker pixel corresponding to a lower intensity. Therefore, in this example, one can make out four distinct light sources: Src1.1, Src2.1, Src3.1, and Src4.1. It should be noted that, in this example, a source is defined by one or more high-intensity pixels, but depending on the use case, a source may be defined by one or more low-intensity pixels.

Watershed algorithms are used to separate an image such as Img1 into several regions corresponding to different objects or light sources. In the example in FIG. 1, a light source corresponds to a local intensity maximum (the “hot spot” of the image), and the watershed algorithm will therefore assign neighboring pixels of lower intensity to this source. However, watershed algorithms are also applicable to the opposite case, i.e. to cases where a source corresponds to a local intensity minimum (a “cold spot” in the image). In the example in FIG. 1, the sources are therefore local intensity maxima in the image obtained by an infrared sensor. However, in other exemplary applications of the invention, the sources may form local minima.

FIG. 2 shows an example of defining light sources in an image for the purposes of applying watershed segmentation.

The image Img2 corresponds to a definition of labels for the pixels in the image Img1. Thus, each of the pixels in the image Img2 corresponds to a pixel in the image Img1 with the same coordinates, and defines a label for this pixel:
The pixels Src1, Src2, Src3, and Src4 respectively correspond to the pixels of four light sources;
The pixels PixI correspond to pixels attributable to a region, i.e. pixels that are not source pixels but can be associated with a source to form a region;
The pixels PixO correspond to pixels not attributable to a region.

The difference between the pixels PixI and PixO may lie in their intensity. For example, in the case of FIGS. 1 and 2, where the sources correspond to low-intensity pixels, the pixels PixO may be pixels with an intensity greater than a threshold considered to be an intensity threshold for the possibility of belonging to a region.

In one state-of-the-art exemplary implementation, the watershed algorithms operate on the principle of a Hierarchical Queue (HQ), i.e. the pixels to be segmented are successively added to the HQ, then are processed and removed from the HQ. The use of the HQ is for example described by the US patent published under number U.S. Pat. No. 4,809,348.

For example, a state-of-the-art watershed algorithm may be as follows:
During a first traversal of the pixels:
   Each source pixel:
      Is placed in a stack corresponding to its radiometry
      Its label is placed in the image Imtrait
   Each detected non-source pixel:
      is marked as to be labeled
      Its level is placed in the image Imtrait
While there are pixels to label:
   While the list is not empty:
      Remove a pixel (i, j) from the stack (highest level)
      Each of these neighbors to be labeled (u, v):
         Is added to the HQ
         Takes the value of the pixel (i, j) in the image Imtrait
         Is no longer declared as to be labeled
   When the stack is empty, a new pixel to be labeled is identified and:
      It is assigned a new label
      It is added to the HQ

In other words, when processing each pixel of the HQ, the pixel's region is propagated to its neighbors to be labeled, which are then themselves added to the HQ.

FIG. 3 shows an example of segmenting an image into regions by using watershed segmentation.

The image Img3 represents the segmentation of the images Img1 and Img2, by using a watershed algorithm as described above.

In the example in FIG. 3, the image has been segmented into four regions Reg1.3, Reg2.3, Reg3.3, and Reg4.3, respectively corresponding to the sources Src1, Src2, Src3 and Src4. The pixels PixO are not assigned to any zone.

The example in FIG. 3 shows that a state-of-the-art watershed algorithm allows an efficient segmentation of the image Img1 into regions associated with different sources. In particular, the watershed segmentation algorithm allows a precise assignment of pixels to each source.

Region segmentation may be used in various image processing applications. For example, it may be used in the context of object detection, where object detection may be performed in each region separately.

While state-of-the-art techniques using the method of hierarchical queue segmentation provide an efficient solution for segmenting an image into regions, they have characteristics that limit their use for real-time applications or in embedded computers:
the traversal through the pixels in the image is not known in advance, and successively-processed pixels may belong to completely different zones of the image. Processing each pixel therefore involves loading new image data, and a slowdown from loading image data from memory implies latency for each pixel;
the processing of each pixel depends on the result of processing the previous pixel. It is therefore not possible to perform pixel processing in parallel.

These limitations are further exacerbated by an increase in image size, which, once the size of an image exceeds the storage capacity of a memory internal to a computing unit performing the image processing, implies storing the images in memories external to the processor performing the image processing, for example DDR SDRAM (Double Data Rate Synchronous Dynamic Random Access Memory) memories. Indeed, memories external to processors generally have high latency. Loading image data for each pixel from an external memory therefore often involves high latency when processing each pixel, which considerably slows down the total image processing time.

One solution for improving the processing time is to reduce the spatial resolution and/or the number of bits per pixel. However, this involves a significant loss of data, and therefore a significant approximation in the result of the separation algorithm.

There is therefore a need for a method for watershed image segmentation that optimizes the processing of image data in order to limit processing time without significantly reducing the quality of the result obtained.

### SUMMARY

This disclosure improves the situation.

A method for watershed segmentation of an image is provided, implemented by a computing unit, which comprises:
obtaining an image, each pixel of the image being associated with: a label indicating whether the pixel is a source pixel, the sources comprising local pixel intensity extrema of a first type; an indicator of a source associated with the pixel; an intensity of the pixel; a pixel intensity extremum of a second type on a path between the source associated with the pixel and the pixel, the second type of pixel intensity extremum being the inverse of the first type of pixel intensity extremum;
at least one iteration of a traversal of successive pixels of the image until a stop criterion is satisfied, said traversal comprising, for each current pixel to be processed in the traversal:
if the pixel is not a source pixel and if, among the current pixel and the neighboring pixels belonging to a neighborhood of said current pixel, the extremum of the first type among the pixel intensity extrema of the second type on the paths between the sources associated with the pixels and the pixels, belongs to a neighboring pixel of said current pixel, or if the pixel is a source pixel and if, among the current pixel and the neighboring pixels belonging to a neighborhood of said current pixel and assigned to the same source, the extremum of the first type among the pixel intensity extrema of the second type on the paths between the sources associated with the pixels and the pixels, belongs to a neighboring pixel of said current pixel:
   if the pixel is not a source pixel, assigning the source indicator of said neighboring pixel to said current pixel;
   assigning, to the value of the intensity extremum of the second type on the path between the source associated with the pixel and the current pixel, the extremum of the second type between:
      the value of the intensity extremum of the second type on the path between the source associated with the neighboring pixel and the neighboring pixel; or
      the intensity of said pixel.

The term “label indicating whether the pixel is a source pixel” is understood to mean information which indicates for each pixel whether or not it is a source pixel. For example, the label may be a Boolean number indicating whether the pixel is a source pixel, a text label indicating “source” or “non-source”, etc. The invention is not limited to a particular type of label.

The term “source indicator” is understood to mean information that allows determining the source associated with the pixel. Source indicators may be of different types. For example, sources may be represented by numbers (1, 2, 3, 4, etc.), text labels (“source A,” source B,” etc.), etc.

“Pixel intensity” is understood to mean a numerical value associated with the pixel, indicating an intensity level associated with the pixel. Pixel intensity representations may be of different types. For example, pixel intensities may be encoded in 8 bits, 16 bits, etc. Pixel intensities are generally represented by unsigned integers. However, the invention is not restricted to this example, and pixels may be represented by any numerical representation enabling a comparison of pixel intensities.

“Intensity extremum” is understood to mean a minimum or a maximum. A type of intensity extremum represents either a maximum or a minimum. “The second type of pixel intensity extremum being the inverse of the first type of pixel intensity extremum” is understood to mean that the second type of extremum is a maximum if the first type of extremum is a minimum, and that the second type of extremum is a minimum if the first type of extremum is a maximum.

Thus, in one set of embodiments of the invention:
the sources may comprise local minima, in which case the pixel intensity extrema of the second type on the paths between the sources associated with the pixels and the pixels are intensity maxima;
the sources may comprise local maxima, in which case the pixel intensity extrema of the second type on the paths between the sources associated with the pixels and the pixels are intensity minima.

“A path between the source associated with the pixel and the pixel” is understood to mean the set of pixels which have, during successive iterations, propagated information between the source and the current pixel.

“Neighborhood of a pixel” is understood to mean a contiguous set of pixels neighboring a current pixel, which may or may not be immediately contiguous neighbors of the current pixel.

In the method according to the invention, the allocation of pixels to the different sources is carried out step by step, so that, on the path leading from a source to a pixel, the extremum of the second type (e.g. the maximum intensity on the path between the source and the pixel, if the source comprises a local intensity minimum, and vice versa) is as close as possible to an extremum of the first type. In other words:
if the sources comprise local minima, the source associated with a given pixel corresponds to the path with the lowest maximum intensity among the paths leading to the different possible sources;
conversely, if the sources comprise local maxima, the source associated with a given pixel corresponds to the path with the highest minimum intensity among the paths leading to the different possible sources.
   This allows for efficient watershed segmentation without requiring any loss of information and therefore without approximation in the obtained result.

In the method according to the invention, the pixels are processed in an order of traversal that is defined in advance. The data to be read is therefore known in advance, which allows anticipating data loads and hiding the latency of accessing data in memory, particularly when using a memory external to the processor performing the operations. In one set of embodiments of the invention, the traversals are performed over successive pixels, for example row by row or column by column. The image data may then be loaded for several contiguous pixels successively, which further limits latency. FIG. 7 provides several examples of possible traversal directions, with four variations for the traversal directions through successive pixels by rows, with all combinations vertically (from bottom to top and from top to bottom), and horizontally (from left to right and from right to left).

In addition, processing successive pixels allows the results of operations on a current pixel to be reused for the next pixel, which reduces the need for accessing external memory, due to using a local cache.

Finally, the deterministic traversal allows several rows of pixels of the image to be processed in parallel, such parallelization of operations making it possible to reduce the processing time of the method significantly.

The method according to the invention therefore allows benefiting from a method for watershed segmentation that provides results of good quality, with reduced processing time and latency which can be adjusted as needed.

According to another aspect, a computer program is provided comprising instructions for implementing the method according to one of the embodiments of the invention when the program is executed by a processor.

According to another aspect, a device is provided comprising at least one computing unit configured to execute the method according to one of the embodiments of the invention.

A “computing unit” is understood to mean an electronic component capable of performing electronic or computerized calculations to carry out a specific function. A computing unit may refer to any type of processor or electronic component capable of performing digital calculations. For example, a computing unit may be an integrated circuit, an ASIC (Application-Specific Integrated Circuit), an FPGA (Field Programmable Gate Array), a microcontroller, a microprocessor, a DSP (Digital Signal Processor), a processor, or a GPU (Graphics Processing Unit). A computing unit according to the invention is not limited to a particular type of computing architecture. For example, a processor may utilize a Harvard or a Von Neumann architecture.

The features set forth in the following paragraphs may optionally be implemented, independently of one another or in combination with one another:

In some embodiments, all pixels in the traversal are pixels to be processed.

In some embodiments, only a subset of the pixels in the traversal is determined as being to be processed.

In some embodiments, the method comprises an initialization step which comprises assigning, to the value of the pixel intensity extremum of the second type on the path between the source associated with the pixel and the pixel: the intensity of the pixel if the pixel is a source pixel; a predefined value otherwise.

In some embodiments, the stop criterion comprises a verification that a predefined number of iterations has been carried out.

This makes it possible to ensure that a number of iterations considered to be sufficient has been executed, while limiting the execution time of the method.

In some embodiments, the stop criterion comprises a verification that the number of pixels modified during an iteration is less than or equal to a threshold.

A “modified pixel” means a pixel for which at least one associated value has been modified during the iteration. An associated value may include the source indicator associated with the pixel, and/or the value of the intensity extremum of the second type on the path between the source associated with the pixel and the pixel.

This makes it possible to stop the iterations when the propagation of values is considered to be sufficient for the information associated with each pixel to no longer fluctuate significantly during a subsequent iteration.

The threshold may, for example, consist of a number of pixels (for example, the criterion may be satisfied if at most 1, 2, or even zero pixels have been modified), or a percentage or ratio of the pixels traversed during the iteration (for example, the criterion may be satisfied if at most 5% or 10% of the pixels traversed have been modified).

In some embodiments, the method comprises a plurality of iterations executed in parallel for a same pixel traversal direction over several strips of the image, the plurality of successive iterations respectively corresponding to a plurality of different image traversal directions.

This makes it possible to process several strips of the image in parallel, and therefore to perform calculation operations in parallel and reduce computing times.

For example, several rows or columns of pixels parallel to each other may be traversed in parallel.

In some embodiments, the method comprises, upon the stop criterion being satisfied, a step of relabeling the pixels located in a region with no source.

A set of pixels does not comprise a source pixel if none of the pixels in the set is associated with a label indicating that it is a source.

This makes it possible, when, at the end of processing, pixels associated with a source are not located in a region of contiguous pixels including the source, to redefine the pixel source labels, in order to merge regions and associate each pixel with the best possible source, which will be located in the same region of contiguous pixels as the pixel is.

In certain embodiments, the neighborhood of the current pixel comprises the set of pixels contiguous to the current pixel.

The use of a neighborhood comprising the set of pixels contiguous to the current pixel allows for more efficient propagation of information relating to sources and extrema, which in certain cases may reduce the number of calculation iterations.

In certain embodiments, the use of a plurality of different pixel traversal directions during several successive iterations respectively.

The use of several different traversals allows for faster convergence of the method, because the data is propagated in several different or even opposite directions.

In some embodiments, the method comprises at least two traversal directions among a group comprising four traversal directions, respectively corresponding to: a traversal of the image from left to right and from top to bottom; a traversal of the image from right to left and from bottom to top; a traversal of the image from right to left and from top to bottom; a traversal of the image from left to right and from bottom to top.

The use of at least two different traversal directions allows for particularly rapid convergence of the pixel values, and therefore reduces the number of calculation iterations.

In some embodiments, the neighborhood comprises only the pixels to be processed in a neighborhood template.

### BRIEF DESCRIPTION OF DRAWINGS

Other features, details and advantages will become apparent upon reading the detailed description below, and upon analyzing the attached drawings, in which:

FIG. 1 shows an example of an image serving as a basis for watershed segmentation.

FIG. 2 shows an example of defining light sources in the image of FIG. 1 with a view to applying watershed segmentation.

FIG. 3 shows an example of segmenting the image of FIG. 1 into regions by watershed segmentation.

FIG. 4 shows an example of a method for watershed image segmentation according to one set of embodiments of the invention.

FIG. 5 shows a simplified example, based on a single spatial dimension, of the principle of watershed segmentation in one set of embodiments of the invention. In this simplified example, the sources are local intensity minima.

FIG. 6 shows two examples of neighborhoods of a pixel according to two embodiments of the invention.

FIG. 7 shows four examples of possible traversals of a two-dimensional image in one set of embodiments of the invention.

FIG. 8 shows the evolution of the variation of pixels of an image during successive iterations, as a function of the traversal directions used, in one exemplary embodiment of the invention.

FIG. 9 shows an example of an experimental result of evaluating the number of iterations necessary to achieve data convergence as a function of a rotation angle applied to the input image, in one exemplary embodiment of the invention.

FIG. 10 shows an example of an image to be segmented, in one exemplary embodiment of the invention.

FIG. 11 shows an example of source detection in an image, in one exemplary embodiment of the invention.

FIG. 12 shows an example of the initial segmentation of an image into regions according to the sources present in the image, in one exemplary embodiment of the invention.

FIG. 13 shows an example of the segmentation of an image into regions after a first propagation iteration, in one exemplary embodiment of the invention.

FIG. 14 shows an example of the segmentation of an image into regions after a second propagation iteration, in one exemplary embodiment of the invention.

FIG. 15 shows an example of the segmentation of an image into regions after a third propagation iteration, in one exemplary embodiment of the invention.

FIG. 16 shows an example of a parallelization structure for parallel processing pixels in one set of embodiments of the invention.

### DESCRIPTION OF EMBODIMENTS

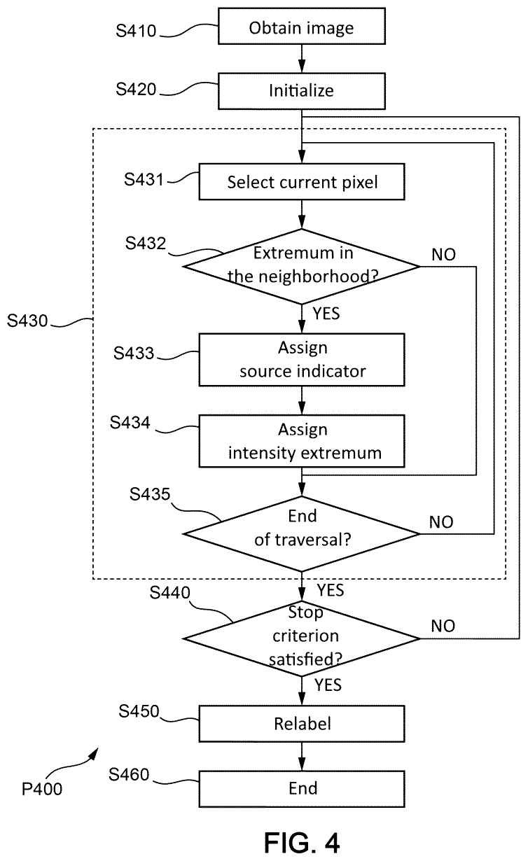

Reference is now made to FIG. 4.

The method P400 is one example of a method for watershed image segmentation according to one set of embodiments of the invention.

The method P400 comprises a first step S410 of obtaining an image.

The image S410 may be obtained in different ways, for example loaded from a file or captured by an image sensor.

The image S410 may be of different types. For example, it may be an infrared, visible light, ultraviolet, or other image. For example, the image may be a radiometry image in which the intensity of each pixel corresponds to the intensity of an infrared signal received by each pixel.

The invention will be described with reference to two-dimensional images, but is not limited to this example, and is applicable for example to images having fewer or greater dimensions than two, for example 1D signals, or 3D volumetric data.

Each pixel of the image is associated with a set of information comprising:
a label indicating whether the pixel is a source pixel, the source pixels being local intensity extrema of a first type;
an indicator of a source associated with the pixel;
an intensity of the pixel;
a pixel intensity extremum of a second type on a path between the source associated with the pixel and the pixel, the second type of pixel intensity extremum being the inverse of the first type of pixel intensity extremum. In the remainder of this disclosure, this value may be referred to as “im_ext”.

Some of this information is fixed and constitutes input data. For example, the intensity of each pixel and the label indicating that it is a source pixel are fixed input data.

Others are intended to be modified during successive iterations and may be initialized to initial values. For example, the source identifier associated with a pixel of non-source pixels may be initialized to a value indicating the absence of a source, and this value may then be updated once the pixel is associated with a source. Similarly, the pixel intensity extremum of a second type on a path between the source associated with the pixel and the pixel may be initialized to a base value, for example the intensity extremum of the first type among all possible pixel intensity values.

The indication of the source pixels and the identifiers associated with each source is obtained as input to the method. This indication may be obtained in different ways. Indeed, many methods exist for selecting sources in an image, such as the H-maxima morphological operation.

It should be noted that a source may comprise one or more pixels, and that only certain pixels are source pixels.

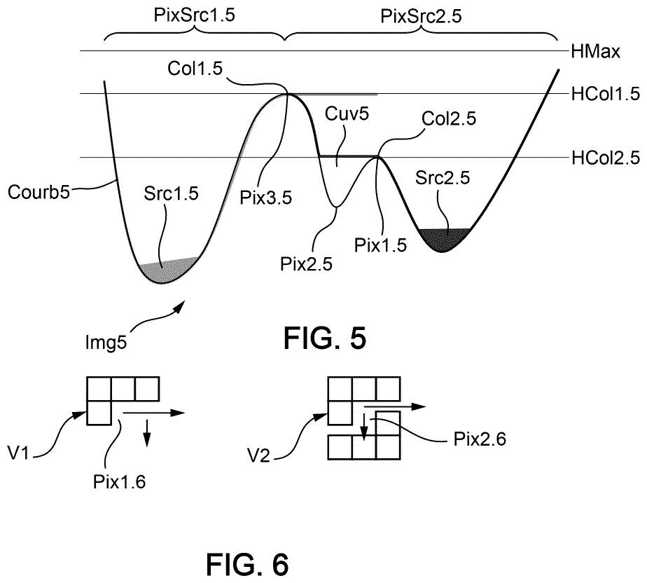

Reference is now made to FIG. 5.

For simplicity, FIG. 5 represents a signal varying as a function of a single spatial dimension Img5, illustrating the operating principle of a method for watershed segmentation according to the invention. FIG. 5 intentionally represents a very simple example, in order to schematically illustrate the operation of a method according to the invention.

Although the image Img5 is an image as a function of a single spatial dimension, the method will be applicable to images of higher dimensions, in particular images in two or three spatial dimensions.

In the example of FIG. 5, the pixel intensity is represented by the altitude of the curve Courb5. Two sources Src1.5 and Src2.5 have been identified in the image. In the example of FIG. 5, the sources comprise local minima. However, not all local minima are necessarily in sources. For example, the image Img5 comprises a basin Cuv5 comprising a local minimum that is not in a source. The image Img5 also comprises local maxima, represented in the image Img5 by “saddles” Col1.5 and Col2.5.

The principle of the watershed segmentation algorithm according to the invention consists of assigning the pixels to each source in such a way that, for each pixel, the “highest saddle crossed” is the lowest possible. For example, in the example in FIG. 5, the pixels PixSrc1.5 will be assigned to the source Src1.5, and the pixels PixSrc2.5 to the source Src2.5. In particular, pixels belonging to the saddle Cuv5 should be assigned to the source Src2.5, because the “highest saddle crossed” Col2.5 is lower than the saddle Col1.5 that should be crossed on the path between the saddle Cuv5 and the source Src1.5.

To this end, the assignment of a source to each pixel is done by propagating the following information from pixel to pixel:
the source to which the pixel belongs;
the maximum height of the “highest saddle” on the path leading from the source to the pixel, i.e. the maximum intensity of the pixels on the path between the source and the current pixel.

When a pixel is already assigned to a first source, this information may be overwritten by information associated with a second source, if and only if the maximum height of the “highest saddle” on the path leading from this second source to the pixel is lower than the maximum height of the “highest saddle” on the path from the first source to the pixel.

In the example in the figure, the sources are local minima. Extrema of the first type are therefore minima, and extrema of the second type are maxima, represented in particular by the saddles. The invention is of course not limited to this example, and the sources may be local maxima (extrema of the first type), while the extrema of the second type are minima.

We will now return to FIG. 4 to present the steps of a method according to one set of embodiments of the invention, before illustrating the operation of the invention in concrete terms, on three pixels Pix1.5, Pix2.5, Pix3.5 of FIG. 5.

In one set of embodiments of the invention, the method P400 comprises a second step S420, an initialization step.

The initialization step S420 may comprise assigning, to the value of the pixel intensity extremum of the second type on the path between the source associated with the pixel and the pixel:
the intensity of the pixel if the pixel is a source pixel;
a predefined value otherwise.

The predefined value may be a global extremum. For example, in the example of FIG. 5, the predefined value may be a global maximum intensity over the image, or a maximum possible intensity value in light of the encoding of the pixel intensity. More generally, this predefined value may be equal to a value between an extremum of the second type among the pixel intensity values over the image, and an extremum of the second type among the possible pixel intensity values.

The initialization step S420 may also comprise assigning, to all pixels that are not source pixels, a predefined indicator indicating that the pixel is not associated with any source.

For example, if the sources are identified by a source number 1, 2, 3 . . . the index 0 may be assigned to each non-source pixel to indicate that it is not associated with any source.

The method P400 then comprises at least one iteration S430 of a traversal through successive pixels of the image. Each traversal iteration consists of traversing the image in a predefined order, then performing calculation steps on at least one pixel in order to allow assigning source indicators to the pixels, step by step.

Generally speaking, operations S431 to S435 will be performed for the pixels referred to as pixels “to be processed”, i.e. pixels for which the mathematical operations will be performed. According to different embodiments of the invention, all or only some of the pixels of the image are to be processed.

In one set of embodiments of the invention, only a subset of the pixels of the traversal is determined as being to be processed, i.e. not all of the pixels of the traversal will have to be processed.

For example, each pixel may be associated with a label indicating whether or not the pixel is to be processed, for example a Boolean value. In this case, the substeps indicated below are performed only for the pixels indicated as being to be processed. The labels may, for example, be determined by a user or by a prior computation step.

The pixels to be processed may also be determined based on the pixel's position in the image. For example, the pixels to be processed may be the pixels located within a central circle of the image with a given radius. Thus, in this example, all pixels located at a distance from the center of the image that is less than the radius of the image will be considered as being to be processed, and the others will not. Of course, this is given solely as a non-limiting example, and many different strategies may be applied for determining the pixels to be processed based on their position in the image.

In embodiments where the pixels to be processed are indicated by a label, the label may also be modified between the different iterations. For example, the number of pixels to be processed may decrease between successive iterations.

Each iteration comprises the following substeps.

A first substep S431 consists of selecting a current pixel.

The pixel selection may be done by successive pixels, meaning that, in the order of traversal, each new current pixel is a pixel neighboring the previous current pixel. The selection may therefore consist of selecting:
a first pixel of the traversal;
or a pixel neighboring the previous pixel, in the order of traversal, or a first pixel of the next row if the previous pixel was a last pixel of a row.

It should be noted, however, that this example is provided solely as a non-limiting example. Pixel traversals that are not on a row-by-row basis may also be used, i.e. the successive pixels are not necessarily contiguous in the order of traversal, provided that the pixel traversal is known in advance, which allows the data to be loaded in advance.

According to various embodiments of the invention, the selection of the current pixel may be carried out on all the pixels of the image or on only some of them.

For example, in the example of FIGS. 2 and 3 where the sources are positioned on local maxima, the pixels PixO must not be associated with a source because their intensity is too low, i.e. below a limit Hmin. These pixels are called background pixels.

In one set of embodiments of the invention, steps S432 to S434 may therefore not be applied to the background pixels.

For example, in the example of FIG. 5 where the sources are positioned on local minima, pixels having an intensity greater than the limit HMax are identified as being background pixels and can be considered as not having to be associated with a source.

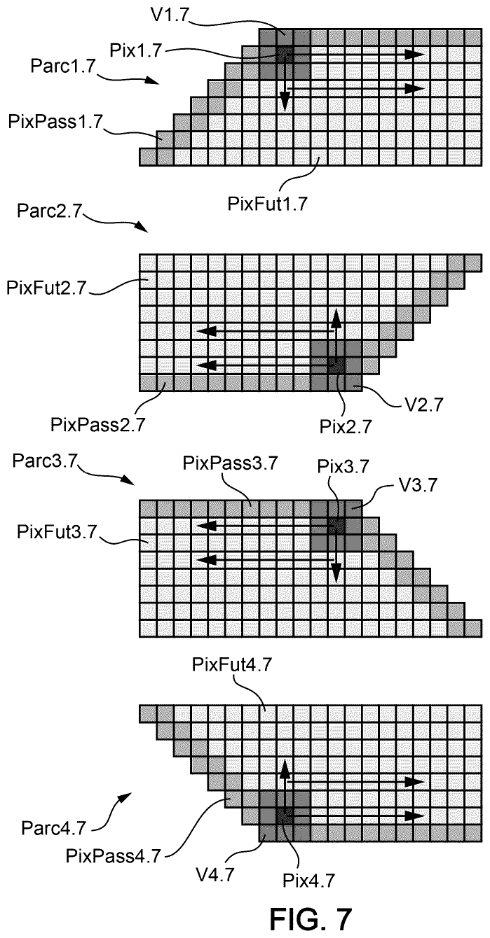

The traversal may be done for example by row, column, diagonally, etc. According to different embodiments of the invention, different orders of traversal are possible; some examples are presented for example in FIG. 7.

A second substep S432 consists of comparing the “im_ext” values of the current pixel and of pixels neighboring the current pixel.

The neighboring pixels are pixels belonging to a neighborhood of the current pixel.

According to some different embodiments of the invention, the neighborhood of the current pixel may take different forms. For example, the neighborhood may comprise all pixels contiguous to the current pixel. Different examples of neighborhood shapes are presented in FIG. 6, for example.

Substep S432 comprises verifying whether the extremum of the first type among the “im_ext” values of the current pixel and of the pixels neighboring the current pixel is associated with the current pixel or with one of its neighbors.

Step S432 is carried out differently depending on whether the pixel is a source pixel or not.

If the pixel is a source pixel, only the neighbors assigned to the same source as the pixel are taken into account for the comparison.

Otherwise, all neighbors are taken into account.

For example, in the example of FIG. 5, the extremum of the first type is a minimum, and the extremum of the second type is a maximum. The “im_ext” value of each pixel therefore corresponds to the maximum pixel intensity encountered on the path leading from the source associated with the pixel to the pixel; If a pixel is not yet associated with a source, its “im_ext” value may have been initialized to a maximum value.

In this example, substep S432 therefore consists of identifying which pixel, among the current pixel and the neighboring pixels, has the lowest “im_ext” value.

If the answer is the current pixel, this pixel is considered as having already been assigned to the source presenting the best path at this iteration.

Otherwise, meaning if a neighboring pixel has the lowest im_ext value, then the source associated with this neighboring pixel is considered to be a better source for the current pixel, since it is associated with crossing a lower saddle.

Of course, this example is provided as one illustrative example in relation to the situation in FIG. 5, where the sources comprise local minima. A reverse reasoning is also possible, where the sources comprise local maxima, and step S432 consists of identifying the pixel having the highest im_ext value.

If the output of step S432 is positive and the pixel is not a source pixel, meaning that the pixel is not a source pixel and the extremum of the first type, among the “im_ext” values of the current pixel and of the pixels neighboring the current pixel, is associated with a neighboring pixel, the iteration S430 comprises a substep S433 of assigning to said current pixel the source indicator of said neighboring pixel. In other words, the source of the neighboring pixel is considered to be a better source for the current pixel, and the source indicator of the neighboring pixel is assigned to the current pixel.

If the output from step S432 is positive, i.e. if the extremum of the first type among the “im_ext” values of the current pixel and of the pixels neighboring the current pixel is associated with a neighboring pixel when the pixel is not a source pixel, or if the extremum of the first type among the “im_ext” values of the current pixel and of the pixels neighboring the current pixel is associated with a neighboring pixel associated with the same source when the pixel is a source pixel, the iteration S430 also comprises a substep S434 of assigning, to the value of the intensity extremum of the second type on the path between the source associated with the pixel and the current pixel, the extremum of the second type between:
the value of the intensity extremum of the second type on the path between the source associated with the neighboring pixel and the neighboring pixel; or
the intensity of said pixel.

In other words, the substep S434 consists of modifying the im_ext value:
either to the im_ext value of the neighboring pixel;
or to the intensity value of the current pixel.

The extremum of the second type of these two options is selected. For example, in the example of FIG. 5 where the extremum of the second type is a maximum, the highest value between the im_ext value of the neighboring pixel and the intensity of the current pixel is selected.

Thus, if the im_ext value of the neighboring pixel is higher than the intensity of the current pixel (which means that the path between the source and the pixel has passed through at least one intensity value, or saddle, that is higher than the intensity of the pixel), this value is assigned to the im_ext value of the current pixel.

Conversely, if the intensity of the current pixel is greater than the im_ext value of the neighboring pixel, which means that the intensity value of the current pixel is higher than all intensity values of the pixels encountered since the source, the im_ext value of the current pixel is assigned its intensity value.

This allows propagating information about the maximum intensity encountered on the path between the source and the current pixel, and to update it if the current pixel has a higher intensity than all those encountered until then.

The iteration S430 then comprises a step S435 consisting of verifying that the pixel traversal has completed. For example, if the traversal is a row, the traversal is considered as finished if the last pixel of the row has been reached.

If the traversal has not completed, the iteration S430 comprises a return to step S431 which consists of selecting the next pixel in the order of traversal, then performing the other operations of the iteration. This allows reducing the processing time, for example to satisfy real-time constraints.

It should be noted that steps S434 and S434 for a current pixel may be performed before or after selecting the next pixel, i.e., the information about a pixel may be updated before or after selecting and processing the next pixel. Thus, according to different embodiments of the invention, the processing for each pixel may be based on data from previous pixels, whether updated or not.

The method P400 comprises, at the end of the iteration S430, a step S440 of verifying a stop criterion. If the stop criterion is not satisfied, the method P400 comprises a new iteration S430 of traversing the pixels.

Different stop criteria may be used, alone or combined.

For example, the stop criterion may comprise verifying that a predefined number of iterations has been completed.

For example, a number of iterations equal to 2, 3, 4, etc. may be performed.

The stop criterion may also comprise verifying that the number of pixels modified during an iteration is less than or equal to a threshold. This ensures the quality of the result obtained.

These criteria are provided solely by way of example, and other criteria may be used in different embodiments of the invention. The criteria may also be combined. For example, the stop criterion may be satisfied if a predefined number of iterations has been performed AND/OR if the number of pixels modified during an iteration is less than or equal to a threshold.

In certain specific cases of images having at least two dimensions, it is possible that pixels associated with a source during an iteration are “cut off” from this source by a series of pixels associated with another source. In this case, a region may be “cut in two” at the end of the iterations.

To correct such cases, in one set of embodiments of the invention, the method P400 may comprise a step (S450) of relabeling pixels located in a region without a source.

In practice, this relabeling step consists of modifying the labels of the pixels located in a region without a source, for example so that each pixel associated with a source is located in a region of contiguous pixels which includes the source. This step may be carried out in several ways.

The relabeling step may comprise a first substep of relabeling by region, in which each region of contiguous pixels associated with the same source is labeled with a unique region label.

In other words, the sets of contiguous pixels of pixels associated with a same source are identified and labeled as a single region. It should be noted here that, as indicated above, the source associated with this set of pixels may not be present if the pixels in the set have been cut off from the source. In this case, there will be at least two contiguous sets of pixels associated with a same source, but having two different and unique region labels.

Next, a substep called the label merging substep may be implemented, to merge each region without a source and a connected region comprising a source.

This label merging substep may be implemented in several ways.

According to a first method, the step of relabeling by region comprises constructing an inter-region connectivity table indicating, for each region, which regions are connected. Then, the label merging substep identifies, for each region without a source, a connected region comprising a source in the table, and assigns the region code of the connected region with a source, to the region without a source.

In the case where a region without a source is connected to several regions with a source, it may be merged with several regions. The choice of region with which to merge may be made in several ways. For example, the first region identified in the table may be selected.

In another example, the neighboring region with which to merge is the one comprising a pixel neighboring the current region having the extremum of the first type among the pixel intensity extrema of the second type on the paths between the sources associated with the pixels and the pixels, which belongs to a pixel neighboring said current pixel.

A “pixel neighboring the region” means a pixel that is not part of the region but is a neighbor of a pixel in the region.

Thus, the region to be merged is the one having the “best neighboring pixel”, i.e. the one through which the region label would have propagated during any successive iterations. This neighboring pixel may be detected during the equivalence determination substep, or stored in the table during the region relabeling substep.

According to a second method, after the region relabeling substep, the label merging step consists of performing a new image traversal in order to merge a region without a source and the first connected region found.

This allows obtaining unique regions comprising the intensity source associated with the pixels, in all cases where such is possible.

At the end of these steps, the method P400 ends S460.

The values associated with each pixel, and in particular the source numbers or the unique region labels, may then be provided as output from the method, for example as input to an image processing method. For example, the associations between pixels and sources or unique region labels may be provided as input to an image classification method, which can classify the different regions independently of each other. Another application may be as input to a process of tracking regions over time (the regions are called plots) if the processing is done on a sequence of video images. Watershed segmentation is used to separate plots into multiple plots when a plot contains several sources.

In general, the method allows segmenting the pixels of an image into regions. Thus, any information which allows identifying the segmented regions may be provided as output from the method.

It should be noted that the pixel traversal iterations may be performed a single traversal at a time, for example with sequential execution of several pixel traversal iterations for a single operator, but also in several parallel traversals (for example, several parallel rows or columns) in order to take advantage of the possibility of parallel processing in the computing operations, and thus considerably reduce the computing times.

For example, several traversals of the image may be performed in several different traversal directions, during a plurality of successive iterations of traversing the image, and, within each traversal iteration, several strips of the image may be processed in parallel in the same traversal direction.

This is possible because the successive pixel traversals are predefined in the method according to the different embodiments of the invention, whereas they are random in the state-of-the-art methods using hierarchical queues.

Reference is again made to FIG. 5.

Application of the method according to the invention will be analyzed using three pixels Pix1.5, Pix2.5, and Pix3.5, in:
a first scenario where the pixels are traversed from right to left, then from left to right;
a second scenario where the pixels are traversed from left to right, then from right to left.

In both scenarios, the im_ext value of the three pixels is initialized to the maximum value Hmax, and the neighborhood of a current pixel includes the pixel immediately to the right and immediately to the left of the current pixel.

In the first scenario, the pixels are traversed from right to left.

Starting from the source Src2.5, each pixel is successively associated with the source Src2.5, and its im_ext value becomes equal to its intensity.

For example, when the pixel Pix1.5 is selected during this first pass, its im_ext value is still equal to HMax, and its source index indicates that it is not associated with any source. The same is true for the pixel immediately to its left.

On the other hand, the pixel immediately to the right has just been associated with the source Src2.5: its source identifier is “Src2.5”, and its im_ext value is equal to its intensity, since that is the highest point encountered so far when starting from the source Src2.5.

In step S432, the im_ext values of the current pixel and of the two neighboring pixels are compared. The im_ext values for the current pixel and its left neighbor are both equal to HMax, but the im_ext value of the right neighbor is slightly lower than HCol2.5. Thus, the minimum of the three values is the im_ext value of the right neighbor.

The method then comprises the execution of steps S433 and S434:
the source “Src2.5” is assigned to the current pixel;
the im_ext value of the pixel Pix1.5 becomes the maximum between the pixel intensity (equal to HCol2.5) and the im_ext value of the right neighbor (slightly less than HCol2.5), i.e. HCol2.5.

The pixel traversal then continues in the basin Cuv5. Here, the pixel intensities are less than HCol2.5, so the information is propagated in which the pixel source is the source Src2.5, but the im_ext values of the pixels in the basin are all HCol2.5.

For example, when the pixel Pix2.5 is selected in this first pass, its im_ext value is still equal to HMax, and its source index indicates that it is not associated with any source. The same is true for the pixel immediately to its left.

On the other hand, the pixel immediately to the right has just been associated with the source Src2.5: its source identifier is “Src2.5”, and its im_ext value is equal to HCol2.5, since that is the highest point encountered so far when starting from the source Src2.5.

In step S432, the im_ext values of the current pixel and of the two neighboring pixels are compared. The im_ext values for the current pixel and its left neighbor are both equal to HMax, but the im_ext value of the right neighbor is equal to HCol2.5. Thus, the minimum of the three values is the im_ext value of the right neighbor.

The method then comprises the execution of steps S433 and S434:
the value of the source “Src2.5” is assigned to the current pixel;
the im_ext value of the pixel Pix1.5 becomes the maximum between the pixel intensity (less than HCol2.5) and the im_ext value of the right neighbor (equal to HCol2.5), i.e. HCol2.5.

Here we see that in the case of a basin, or more generally of pixels having a lower intensity than the maximum intensity encountered on the path from the source, the source indicator is propagated, but the im_ext values of the pixels all take the maximum pixel intensity encountered on the path, here HCol2.5.

On the rest of the traversal, after exiting the basin, i.e. when the pixel intensity becomes greater than HCol2.5 again, the source indicator continues to be propagated, but the im_ext values of the various pixels are the pixel intensities, since each time this is the maximum intensity encountered since the source.

For example, the pixel Pix3.5 is located just to the right of the saddle Col1.5. The reasoning applied to the pixel Pix1.5 is applied in the same manner, such that, at the end of the iteration:
the value of the source “Src2.5” is assigned to the pixel Pix3.5;
the im_ext value of the pixel Pix3.5 becomes its intensity, slightly lower than HCol1.5.

During the second pass, from left to right, the source indicator Src1.5 is propagated to the saddle Col1.5.

When the pixel Pix3.5 is selected, the test S432 is applied, i.e. the im_ext values are compared between the current pixel Pix3.5 and its left and right neighbors.

In the current case:
the im_ext value of the left neighboring pixel, located on saddle Col1.5, is equal to HCol1.5;
the im_ext value of the current pixel Pix3.5 is slightly lower;
the im_ext value of the right neighbor is even lower.

The minimum of the three im_ext values is therefore that of the right neighbor, associated with the source Src2.5. A propagation identical to the first pass may therefore be performed, which does not modify any value associated with the pixel Pix3.5.

We can see here that the propagation of the source identifier Src1.5 is stopped just after the saddle Col1.5, because the maximum value encountered when starting from the source Src1.5 is equal to HCol1.5, while the maximum values encountered when starting from the source Src2.5 are lower.

Let us now examine a second scenario, where a first traversal is performed from left to right, then a second traversal from right to left.

During the first traversal, all im_ext values of non-source pixels are equal to HMax, and are not associated with any source. Starting from the source Src1.5, all pixels between the source Src1.5 and the source Src2.5 are therefore associated with the source Src1.5, and the im_ext values of pixels between the saddle Col1.5 and the source Src2.5 become equal to HCol1.5, which is the maximum pixel intensity encountered, at the saddle Col1.5, when starting from the source Src1.5.

During the second pixel traversal, from right to left, all pixels between the pixel Pix3.5 and the source Src2.5 are assigned to the source Src2.5.

Indeed, when the condition of step S432 is evaluated for each pixel located between the source Src2.5 and the pixel Pix3.5, the im_ext value of the current pixel is equal to HCol1.5, which is the maximum value encountered when starting from Src1.5, but the im_ext value of the neighboring pixel on the right is lower, since it is the maximum value encountered when starting from Src2.5.

All of the reasoning carried out for the first path, from right to left, of the first scenario may therefore be reproduced, with the difference that the im_ext value of the current pixel is equal to HCol1.5 and not HMax.

Thus, by scanning the pixels from right to left, all pixels between Src2.5 and Pix3.5 are reassigned to the source Src2.5.

We can therefore see that, in both cases, the method according to one embodiment of the invention allows segmenting the image Img5 into two regions separated by the saddle Col1.5, and that this separation provides a consistent separation between the different sources, where the source associated with each pixel is the one for which the path from the source to the pixel crosses the lowest possible saddle.

Of course, the example in FIG. 5 is provided solely as an illustrative and simplified example, and other logical approaches for propagating information are possible within the scope of the invention.

For example, the sources may be local maxima rather than minima. In such case, all logic must be reversed, searching for minima instead of maxima and vice versa. In such case, the initialization value HMax becomes a minimum Hmin, and the sources assigned to each pixel are the sources for which the minimum intensity encountered on the path from the source to the pixel is the highest.

In the case of 2D images, the pixel neighborhood is generally also in 2D, which allows considering 2D paths from a source to a pixel. The same is true for 3D volumetric images.

Reference is now made to FIG. 6.

FIG. 6 shows two examples of neighborhoods of a pixel according to two embodiments of the invention.

In both cases, the neighborhood concerns a 2D image, and the pixels are traversed from left to right, then from top to bottom of the image. In other words, the image is traversed row by row, from top to bottom, and, within each row, the traversal is from left to right.

In both cases, the masks V1 and V2 contain only pixels contiguous to the current pixel, i.e. the pixels immediately above, below, to the left, to the right, and diagonal to the current pixel.

The neighborhood V1 is defined around a current pixel Pix1.6, and comprises the contiguous pixels already traversed during traversal of the pixels, i.e.:
the three contiguous pixels belonging to the upper row (upper left pixel, upper pixel, upper right pixel);
the pixel immediately to the left of the current pixel, in the same row.

The neighborhood V2 is defined by the set of pixels contiguous to the current pixel Pix2.6, whether or not they have already been traversed during the traversal of pixels, i.e.:
the three contiguous pixels belonging to the upper row (upper left pixel, pixel immediately above, upper right pixel);
the pixel immediately to the left of the current pixel, in the same row;
the pixel immediately to the right of the current pixel, in the same row;
the three contiguous pixels belonging to the lower row (lower left pixel, pixel immediately below, lower right pixel).

The neighborhoods presented in FIG. 6 are provided solely as examples of neighborhoods usable in embodiments of the invention, and other pixel neighborhoods are conceivable, using only contiguous pixels or not.

Using a neighborhood comprising pixels contiguous to the current pixel allows for efficient propagation of information relating to sources and extrema, while limiting the number of operations to be performed.

Using a neighborhood such as the neighborhood V1, comprising only pixels contiguous to the current pixel that have already been traversed, allows limiting the computational complexity of the method.

Using a neighborhood such as the neighborhood V2, comprising all pixels contiguous to the current pixel, allows a more efficient propagation of information relating to sources and extrema, which in some cases can limit the number of computational iterations.

However, although the examples in FIG. 6 show neighborhoods containing only pixels contiguous to the current pixel, larger neighborhoods may be defined, which for example could reduce the number of passes.

FIG. 6 shows examples of fixed neighborhoods, i.e. examples for which a same neighborhood is applied around each current pixel. However, in certain embodiments, the neighborhood may be variable depending on the current pixel to be processed.

For example, the neighborhood may only include the neighboring pixels to be processed. For example, a given neighborhood template may be considered, such as the neighborhood V2, and, for a given current pixel, only the neighboring pixels to be processed in the neighborhood template will be integrated into the neighborhood of the current pixel and considered.

For example, if, for a current pixel Pix2.6, in the neighborhood V2 only the pixel immediately above and immediately to the left are determined as being to be processed, the neighborhood actually taken into account for processing pixel Pix2.6 will not be the entire neighborhood V2 but will only include the pixels immediately above and immediately to the left.

Reference is now made to FIG. 7.

FIG. 7 shows four types of traversals:
a traversal Parc1.7 called a “video traversal” in which the image is traversed from left to right and from top to bottom;
a traversal Parc2.7 called an “anti-video traversal ” in which the image is traversed from right to left and from bottom to top;
a traversal Parc3.7 called a “reverse video path” in which the image is traversed from right to left and from top to bottom;
a traversal Parc4.7 called “reverse anti-video path” in which the image is traversed from left to right and from bottom to top.

In each of these examples, a current pixel Pix1.7, Pix2.7, Pix3.7, and Pix4.7 is represented, each of the current pixels being respectively associated with a neighborhood V1.7, V2.7, V3.7, and V4.7.

This example shows how the information contained in the pixels Pix1.7, Pix2.7, Pix3.7 and Pix4.7 is respectively propagated.

For example, the pixel traversal Parc1.7 is from left to right and from top to bottom. The propagation of information is therefore essentially downwards and to the right, in the zone labeled PixFut1.7, even if the use of the neighborhood V2 allows information to be propagated slightly to the left, with a shift of the zone where the information is propagated by one pixel in each row, and on the row above pixel Pix1.7, allowing information to be propagated to the pixels in the zone PixPass1.7.

The pixel traversal Parc2.7 is from right to left and from bottom to top. The propagation of information is therefore essentially upwards and to the left, in the zone labeled PixFut2.7, even if the use of the neighborhood V2 allows information to be propagated slightly to the right, with a shift of the zone where the information is propagated by one pixel in each row, and on the row below pixel Pix2.7, allowing information to be propagated to the pixels in the zone PixPass2.7.

The pixel traversal Parc3.7 is from right to left and from top to bottom. The propagation of information is therefore essentially downwards and to the left, in the zone labeled PixFut3.7, even if the use of the neighborhood V2 allows information to be propagated slightly to the right, with a shift of the zone where the information is propagated by one pixel in each row, and on the row above pixel Pix3.7, allowing information to be propagated to the pixels in the zone PixPass3.7.

The pixel traversal Parc4.7 is from left to right and from bottom to top. The propagation of information is therefore essentially upwards and to the right, in the zone labeled PixFut4.7, even if the use of the neighborhood V2 allows information to be propagated slightly to the left, with a shift of the zone where the information is propagated by one pixel in each row, and on the row below pixel Pix4.7, allowing information to be propagated to the pixels in the zone PixPass4.7.

In other examples, the use of different traversal directions and/or of neighborhoods may imply a different propagation of information.

According to different embodiments of the invention, a same image traversal may be used, or several different image traversals may be used, during the different successive iterations.

For example:
at least two traversals chosen among the four traversals shown in FIG. 4;
two image traversals corresponding to opposite traversal directions over rows and/or columns may be used;
four image traversals corresponding to the four possible combinations of image traversal directions over respective rows and columns (e.g. the four traversals Parc1.7, Parc2.7, Parc3.7, Parc4.7) may be used.

Using several different traversals allows a faster convergence of the method, because data is propagated in several different or even opposite directions. This is true for two different traversals, and even more so for four different traversals.

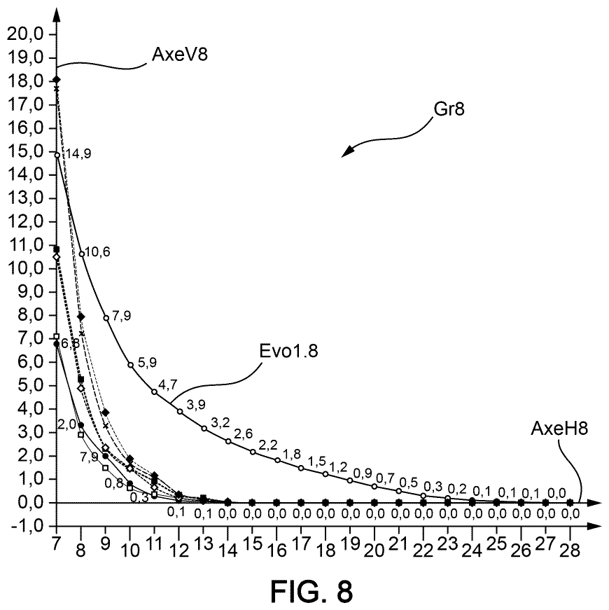

Reference is now made to FIG. 8.

The graph Gr8 represents the evolution of the variation of pixels of an image during successive iterations, as a function of the traversal directions used, in one exemplary embodiment of the invention.

The vertical axis AxeV8 represents the percentage of pixels modified in an iteration.

The horizontal axis AxeH8 represents the index of the current iteration.

The seven curves therefore represent the evolution of the percentage of pixels modified during successive iterations.

The curve Evo1.8 represents an example where only two traversal directions are used. The other curves represent examples where four traversal directions are used. The numbering “V1” to V6” corresponds to the six different orders combining the four possible image traversal directions in succession. By convention, this begins with the direct video traversal (Parc1.7) and there are then 3*2*1=6 possible orders of traversal to perform four successive traversals.

One will note that the state of the pixels tends to converge, i.e. the percentage of pixels modified in each iteration decreases until it trends to a zero value.

One will also note that convergence is much faster when four traversal directions are used, i.e. the number of iterations required so that no or almost no pixels are modified is much lower. If the stop criterion used in step S440 is a data convergence criterion, the number of iterations used by the method will therefore be lower.

This example therefore shows that using four traversal directions allows reducing the number of iterations required for the method to converge, and therefore allows reducing the computing time for a given image.

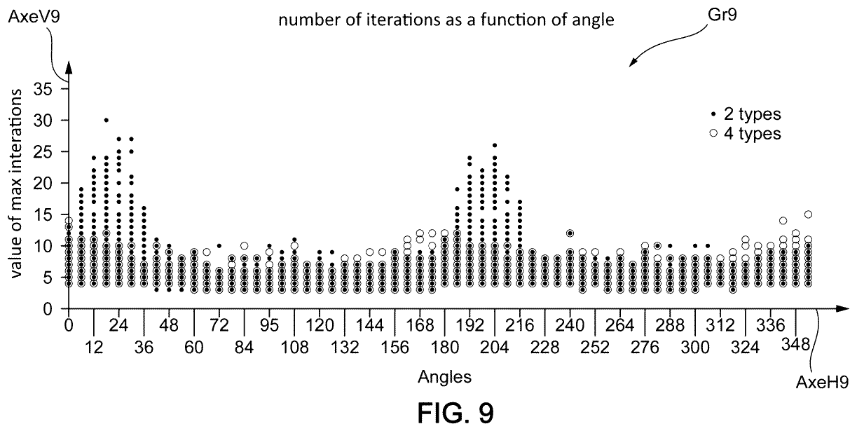

Reference is now made to FIG. 9.

The graph Gr9 shows an example of an experimental result in evaluating the number of iterations required to achieve data convergence as a function of an angle of rotation applied to the input image, in one exemplary embodiment of the invention.

In this example, a rotation is applied to the input image before starting the method. The set of angles applied to the image corresponds to angles uniformly distributed from 0° to 354°, with an increment of 6°. The image is therefore rotated by 0°, 6°, 12°, 18° . . . 354° in the different cases.

The horizontal axis AxisH9 represents the rotation angle applied to the image.

The vertical axis AxisV9 represents the number of iterations required to converge.

The method for image segmentation is then applied to the image at the different rotations.

The points on the graph represent the number of iterations required to converge, as a function of the angle of rotation of the same image while using two or four types of traversals. This figure therefore provides an indication of the variability of the number of iterations required to converge as a function of the image, depending on whether two or four types of traversals are used.

One can see that the number of iterations required to converge varies significantly with the angle applied to the image when two image traversals are used, but much less if four image traversals are used. This example therefore shows that using the four image traversals Parc1.7, Parc2.7, Parc3.7, and Parc4.7 allows limiting the number of iterations required to converge, regardless of the image.

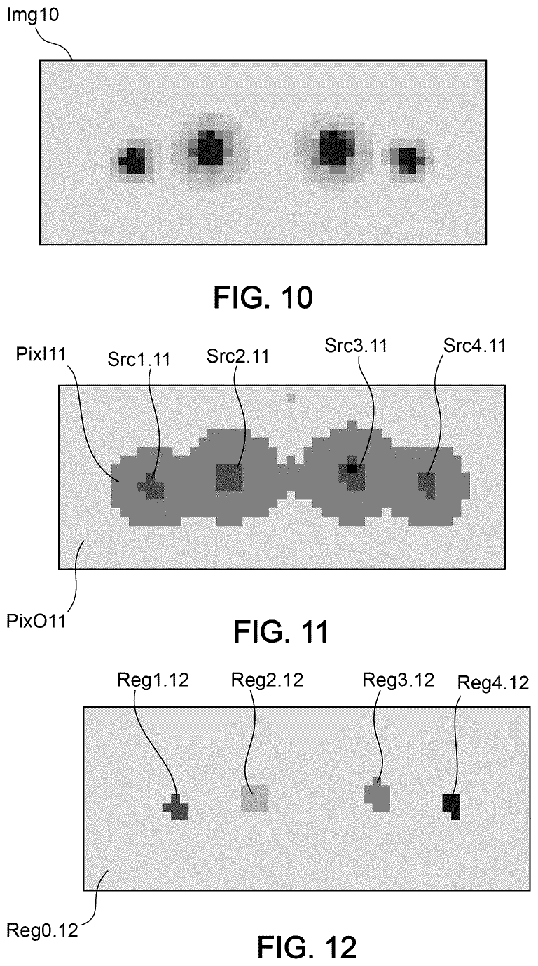

Reference is now made to FIGS. 10 to 15.

FIGS. 10 to 15 represent several successive steps of a method for segmenting an image according to one exemplary embodiment of the invention.

In FIG. 10, an image Img10 is obtained.

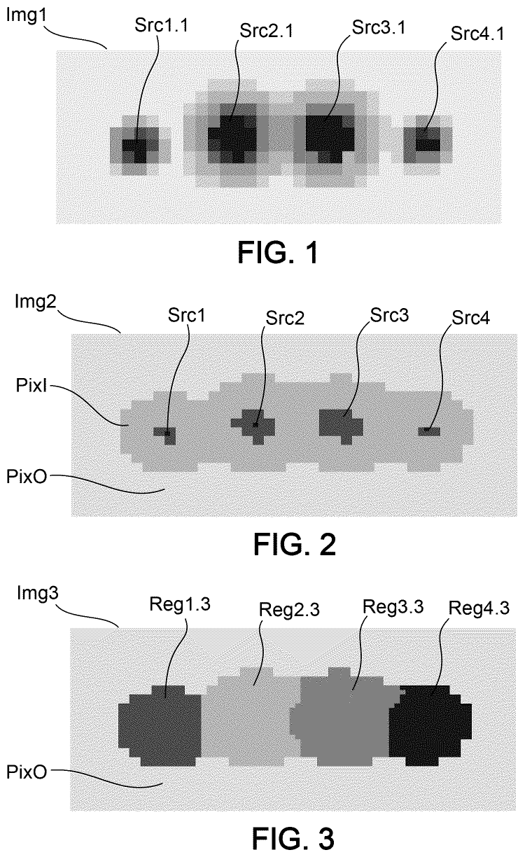

As in the example of FIG. 1, the intensity of each pixel increases with the gray level, a darker pixel corresponding to a greater intensity.

FIG. 11 represents detection of sources, applied to the image Img10.

The color code is the same as in FIG. 2:
four sources Src1.11, Src2.11, Src3.11, and Src4.11 have been detected;
the pixels PixI11 can be associated with a source;
the pixels PixO11 cannot be associated with a source (background pixels).

FIG. 12 shows the initial association of source labels with image pixels: pixels in the four regions Reg1.12, Reg 2.12, Reg 3.12, and Reg 4.12 are respectively associated with labels from the four sources Src1.11, Src2.11, Src3.11, and Src4.11. Pixels in the region Reg0.12 are not associated with any source, either because they are part of the background (PixO11 in FIG. 11) or because they have not yet been labeled at this stage (PixI11 in FIG. 11). One will note that at this stage, only source pixels are associated with a source.

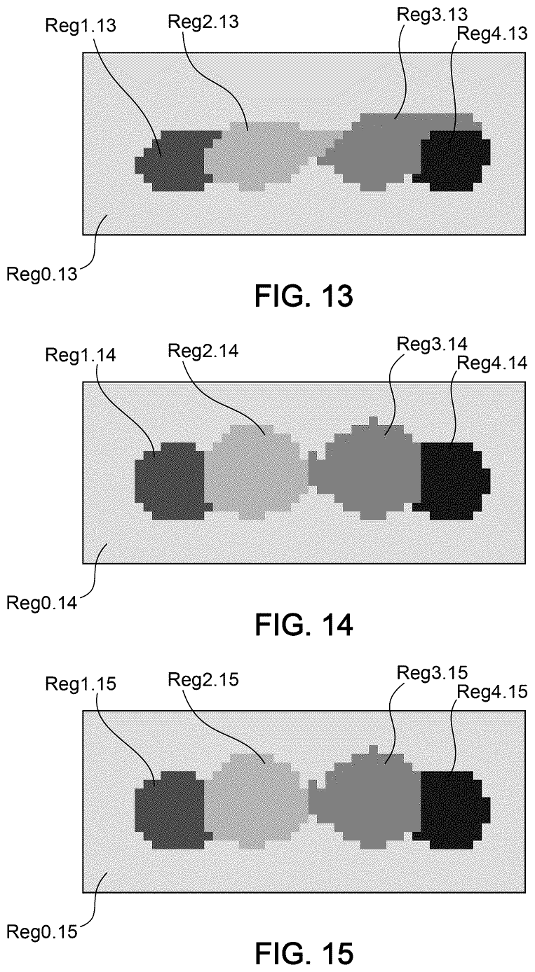

FIG. 13 shows the labeling of the sources after a first iteration of traversing the image pixels. The pixels of the four regions Reg1.13, Reg2.13, Reg3.13, and Reg4.13 are respectively associated with labels of the four sources Src1.11, Src2.11, Src3.11, and Src4.11. The pixels of the region Reg0.13 are not associated with any source. The traversal used for this iteration is the first type of traversal Parc1.7. One will note that at this stage, information propagation “cones” on the sources are visible, particularly for region Reg3.13, due to the propagation of information as shown in reference to FIG. 7.

FIG. 14 shows the labeling of sources after a second iteration of traversing the image pixels, according to a second type of traversal which is different from the first. The pixels in the four regions Reg1.14, Reg2.14, Reg3.14, and Reg4.14 are respectively associated with labels of the four sources Src1.11, Src2.11, Src3.11, and Src4.11. The pixels in the region Reg0.14 are not associated with any source.

FIG. 15 shows the labeling of the sources after a third iteration of traversing the image pixels, according to a third type of traversal which is different from the first and second. The pixels in the four regions Reg1.15, Reg2.15, Reg3.15, and Reg4.15 are respectively associated with labels of the four sources Src1.11, Src2.11, Src3.11, and Src4.11. The pixels in the region Reg0.15 are not associated with any source. No changes to the source labels are made relative to the second iteration, so the iterations stop at the third because the convergence criterion is satisfied. In this example, the convergence criterion concerns a number of modified pixel source labels that is below a given threshold between two iterations. In this example, the threshold is equal to 1, but no source labels were modified between the second and third iterations.

One will observe that the method according to the invention allows rapid convergence in the segmentation of image pixels into regions associated with the different sources detected.

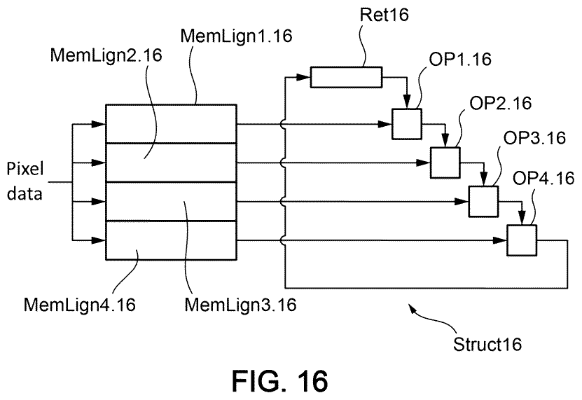

Reference is now made to FIG. 16.

The method according to one of the embodiments of the invention may be implemented on different types of computing units, for example such as:
integrated circuits such as FPGAs, ASICS,
processors, such as microprocessors, CPUs, DSPs, or GPUs.

As indicated above, the method according to one embodiment of the invention has characteristics that allow reducing its execution time, in particular when it is implemented on an integrated circuit where an image is loaded from an external memory:
the traversals are performed by successive pixels. The image data may therefore be loaded for several pixels successively, which reduces latency in loading data when a memory external to the processor performing the operations is used;
processing by successive pixels allows reusing the results from operations on a current pixel, for the next pixel;
the deterministic traversal allows processing several rows of pixels of the image in parallel, the parallelization of operations making it possible to reduce the processing time of the method significantly.

FIG. 16 thus shows one example of a parallelization structure Struct16 for parallel processing pixels in one set of embodiments of the invention.

During certain image traversals, the operations performed on a pixel depend on the result from the row above. In such case, in order to comply with the principle that the information of a pixel is updated before processing the next pixel, the processing of the different rows can be shifted. The current pixel of a row may thus be updated and then sent to the structure that is calculating the current pixel of another row (two processors processing two consecutive rows therefore do not work on the same column, but on two columns offset by at least one position).

In the example in FIG. 16, a strip of four rows is loaded into memory, the four rows being respectively loaded into four areas of memory MemLign1.16, MemLign2.16, MemLign3.16, and MemLign4.16.

These four rows are respectively processed by four operators OP1.16, OP2.16, OP3.16, and OP4.16. The parallelization structure Struct16 also comprises, in this example, a delay row Ret16 which represents the last row of the previous strip. This makes it possible to avoid rereading, from external memory, information already read or written, for the information modified during the traversal.

At the end of processing the strip of four rows, the last row of the strip becomes the delay row Ret16 in order to avoid reloading this row for processing the next strip.

The structure Struct16 is provided solely as a non-limiting example of a parallelization structure according to one embodiment of the invention. Other parallelization structures are conceivable. For example, another example of a parallelization structure according to the invention could work on four pixels aligned in a same row. This would require less bandwidth to read the data, and would allow comparisons to be shared (some of the comparisons between neighbors of the current pixel may be used to process the next pixel). This allows reducing the amount of computing resources required for processing.

This disclosure is not limited to the examples of a method, device, and computer program described above solely by way of example, but encompasses all variants conceivable to a person skilled in the art within the framework of the protection sought.

1. A method (P400) for watershed segmentation of an image, implemented by a computing unit executing instructions stored in a non-transitory computer readable memory, which comprises:
obtaining (S410) an image, each pixel of the image being associated with:
a label indicating whether the pixel is a source pixel, the sources comprising local pixel intensity extrema of a first type;
an indicator of a source associated with the pixel;
an intensity of the pixel;
a pixel intensity extremum of a second type on a path between the source associated with the pixel and the pixel, the second type of pixel intensity extremum being the inverse of the first type of pixel intensity extremum;
at least one iteration (S430) of a traversal of successive pixels of the image until a stop criterion is satisfied (S440), said traversal comprising, for each current pixel to be processed in the traversal:
if the pixel is not a source pixel and if, among the current pixel and the neighboring pixels belonging to a neighborhood of said current pixel, the extremum of the first type among the pixel intensity extrema of the second type on the paths between the sources associated with the pixels and the pixels, belongs to a neighboring pixel of said current pixel, or
if the pixel is a source pixel and if, among the current pixel and the neighboring pixels belonging to a neighborhood of said current pixel and assigned to the same source, the extremum of the first type among the pixel intensity extrema of the second type on the paths between the sources associated with the pixels and the pixels, belongs to a neighboring pixel of said current pixel (S432):
if the pixel is not a source pixel, assigning (S433) the source indicator of said neighboring pixel to said current pixel;
assigning (S434), to the value of the intensity extremum of the second type on the path between the source associated with the pixel and the current pixel, the extremum of the second type between:
the value of the intensity extremum of the second type on the path between the source associated with the neighboring pixel and the neighboring pixel; or
the intensity of said pixel.

2. The method according to claim 1, wherein all pixels in the traversal are pixels to be processed.

3. The method according to claim 1, wherein only a subset of the pixels in the traversal is determined as being to be processed.

4. The method according to claim 1, comprising an initialization step (S420) which comprises:
assigning, to the value of the pixel intensity extremum of the second type on the path between the source associated with the pixel and the pixel:
the intensity of the pixel if the pixel is a source pixel;
a predefined value otherwise.

5. The method according to claim 1, wherein the stop criterion comprises a verification that a predefined number of iterations has been carried out.

6. The method according to claim 1, wherein the stop criterion comprises a verification that the number of pixels modified during an iteration is less than or equal to a threshold.

7. The method according to claim 1, comprising a plurality of iterations executed in parallel for a same pixel traversal direction over several strips of the image, the plurality of successive iterations respectively corresponding to a plurality of different image traversal directions.

8. The method according to claim 1, comprising, upon the stop criterion being satisfied, a step (S450) of relabeling the pixels located in a region with no source.

9. The method according to claim 1, wherein the neighborhood (V2) of the current pixel comprises the set of pixels contiguous to the current pixel.

10. The method according to claim 1, comprising the use of a plurality of different pixel traversal directions during several successive iterations respectively.

11. The method according to claim 10, comprising the use of at least two traversal directions among a group comprising four traversal directions, respectively corresponding to:
a traversal of the image from left to right and from top to bottom (Parc1.7);
a traversal of the image from right to left and from bottom to top (Parc2.7);
a traversal of the image from right to left and from top to bottom (Parc3.7);
a traversal of the image from left to right and from bottom to top (Parc4.7).

12. The method according to claim 1, wherein the neighborhood comprises only the pixels to be processed in a neighborhood template.

13. A non-transitory computer readable storage medium, storing a computer program comprising instructions which, when executed by a computing unit, implement the method according to claim 1 when this program is executed by a processor.

14. A device comprising at least one computing unit configured to execute the method according to claim 1.
